(19) United States
(12) Patent Application Publication
(10) Pub. No.: US 2008/0288347 A1
(43) Pub. Date: Nov. 20, 2008

(54) ADVERTISING KEYWORD SELECTION BASED ON REAL-TIME DATA

(75) Inventor: David Sifry, San Francisco, CA (US)

Correspondence Address: BEYER WEAVER LLP, P.O. BOX 70250, OAKLAND, CA, 94612-0250, US

(73) Assignee: TECHNORATI, INC., San Francisco, CA (US)

(21) Appl. No.: 11/774,497

(22) Filed: Jul. 6, 2007

Related U.S. Application Data
(60) Provisional application No. 60/930,828, filed on May 18, 2007.

(51) Int. Cl. G06Q 30/00

(52) U.S. Cl. 705/14

(57) ABSTRACT

Methods and apparatus are described for selecting advertising keywords for advertising campaigns. A set of keywords is identified from a dynamic data set. The dynamic data is generated from at least one data source which is updated via the Internet substantially in real time. Each keyword in the set of keywords is characterized in the dynamic data set by a current relevancy measure not yet apparent from conventional search engine databases. A subset of the keywords is selected for use in the advertising campaigns with reference to at least one current market condition relating to each selected keyword. Advertising campaigns are initiated for each of the selected keywords.

### BACKGROUND OF THE INVENTION

The present invention relates to online keyword advertising and, in particular, to techniques for selecting keywords for online advertising campaigns which are currently relevant.

The market for online advertising is dominated by a model in which providers of Web search services, e.g., Google, Microsoft, Yahoo, etc., enable advertisers to bid on keywords which, when included in search queries entered by users of the provider's search engine, result in advertisements from the advertisers being presented on a page of “organic” search results returned in response to the search query. The page and the order in which the ads are displayed (e.g., from top to bottom along side the organic search results), are determined with reference to the amount each respective advertiser has bid for the keyword.

These bids correspond to the amount each advertiser is willing to pay the search provider each time a user selects or “clicks” on their ads, and thus represent the “cost per click,” i.e., the CPC, for each keyword. Each search provider typically has a default minimum required CPC bid for any keyword, e.g., 1-5 cents, which may then go up from there depending on the current demand for the keyword and/or the past history of the keyword.

The manner in which advertisers select keywords typically involves human decision making which is, more often than not, based on anecdotal evidence and/or individual marketing expertise, and often bears little relation to the issues and topics in which users on the Web are currently expressing an interest.

### SUMMARY OF THE INVENTION

According to the present invention, methods and apparatus are provided for selecting advertising keywords for advertising campaigns. A set of keywords is identified from a dynamic data set. The dynamic data is generated from at least one data source which is updated via the Internet substantially in real time. Each keyword in the set of keywords is characterized in the dynamic data set by a current relevancy measure not yet apparent from conventional search engine databases. A subset of the keywords is selected for use in the advertising campaigns with reference to at least one current market condition relating to each selected keyword. Advertising campaigns are initiated for each of the selected keywords.

According to various embodiments, the at least one data source may be one or more of a live data feed, search query traffic, or an event-based data aggregation system.

According to various embodiments, any of the identification of the keywords, the selection of the subset of the keywords, and the initiation of the advertising campaigns may be iterated. In addition or alternatively, the advertising campaigns may be monitored with reference to at least one performance metric, and subsequently modified or terminated in response thereto.

According to some embodiments, the keywords may be identified by performing a frequency analysis on the dynamic data set to identify frequently occurring words. According to one such embodiment, at least some of the frequently occurring words are compared to a baseline frequency measure representing historic usage of the at least some of the frequently occurring words.

According to various embodiments, the at least one current market condition relating to each selected keyword may be one or more of a current number of bids for the selected keyword, a current minimum bid price for the selected keyword, a first bid price required to guarantee ad placement on a page of organic search results, or a number of ads displayed on each page of organic search results.

According to various embodiments, the dynamic data set may be characterized by one or more of a subject matter area, relative authority of content publishers associated with the at least one data source, a social network, a collection of blogs, or any editorially determined data source.

A further understanding of the nature and advantages of the present invention may be realized by reference to the remaining portions of the specification and the drawings.

### BRIEF DESCRIPTION OF THE DRAWINGS

FIG. 1 is a flowchart illustrating operation of an example of a technique for selecting keywords according to a specific embodiment of the invention.

FIG. 2 is a network diagram of an example of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention enable automated techniques which employ “real-time” and/or “near-real-time” information to select keywords for use in advertising campaigns. As used herein, the terms “real-time” and “near-real-time” describe dynamic data sources which are updated substantially in real time, e.g., in response to publication events (e.g., on the Web or the Internet generally), rather than the manner in which, for example, conventional search databases are updated, i.e., by iterative crawling the of the Web. The qualitative difference in terms of the currency of information is on the order of seconds, minutes, or hours for the former, versus days, weeks, or months for the latter. As such, embodiments of the invention are able to deal with anticipated pricing irregularities, e.g., “unnaturally” low prices for keywords, to effectively beat the market to such keywords.

According to various specific embodiments, such automated techniques use information about breaking or about-to-break news or events in conjunction with APIs made available by CPC advertising providers (e.g., Google's adwords API, Microsoft's ad center API, Yahoo's publisher network API, etc.) to identify keywords having suitably low CPCs and/or few or no current bids, and then to effect advertising campaigns with those keywords before the relevancy of the keywords becomes more generally apparent to the marketplace.

For example, if an event occurred within the last hour or so involving an individual, e.g., a celebrity or politician, and an object or place not typically associated with the individual, chances are that there would be significant search engine activity using keywords including the individual's name and the object or place. Unfortunately, because of the manner in which conventional search engine databases are updated, the results from such searches would not be very satisfying to the users. That is, most of the top level results would involve generic information about the individual of which, presumably, there is a considerable amount on the Web.

However, if one has access to a data set which is generated from real-time or near-real-time data sources, the association between the individual's name and the object or place will become apparent well before it becomes apparent to others on the Web, thus conferring an advantage in terms of identifying and using the historically atypical combination as an advertising keyword. That is, when such a currently relevant keyword is identified in such a manner, advantage may be taken of the APIs made available by search engine providers to determine whether and how many bids are placed on the keyword, and at what CPC. If the keyword is an historically unusual combination, the chances are that there are few or no bids on the combination and/or the CPC for the keyword is at the search engine provider's minimum bid. Put another way, because of the currency of the keyword relevancy information, an opportunity exists to use the keyword to get highly placed ads for a very low price before the market adjusts to the rising importance of the keyword.

In addition, because the organic search results for such newly relevant keywords are likely to be unsatisfying to users for some time, the likelihood that users will actually respond to advertisements accompanying the organic results by selecting them goes up dramatically, i.e., the click-through rate or CTR, an important figure of merit in online advertising, may be significantly higher than usual (e.g., by one or more orders of magnitude). This is particularly the case where the ad content is in some way related to the keywords themselves, i.e., the ads are more relevant than the organic search results. Thus, as will be discussed, embodiments of the present invention may also result in abnormally high CTRs for very low CPCs, at least for a period of time, i.e., until the market catches up with the relevance of the keyword.

As used herein, the term “keyword” is used as it is understood in the online advertising field. That is, a keyword may comprise a word or a phrase comprising multiple words in various combinations. CPC bids may be placed on such keywords with providers of advertising services such as, for example, search engine providers.

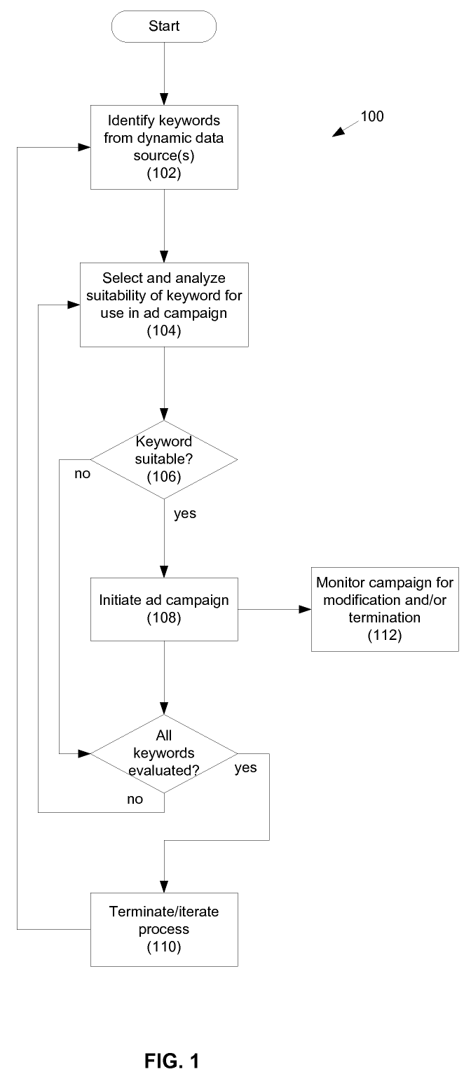

A particular class of embodiments will now be described with reference to flowchart 100 of FIG. 1. According to such embodiments, a set of keywords is determined from a data set derived from one or more dynamic data sources which are updated in real time or near real time (102). According to various embodiments of the invention, the data source(s) may comprise any of a wide variety of data sources (alone or in combination) without departing from the scope of the invention. For example, the data source(s) may include one or more live data feeds on the Web or the Internet, e.g., RSS feeds, from which information is extracted as it comes in. In another example, the data source(s) may be derived from search queries entered into a Web search engine by users. That is, analysis of live search query traffic may be employed to identify the most currently relevant keywords.

As yet another example, the data source(s) may be generated by an event-based data aggregation system in which data, e.g., Web data, are indexed in response to event notifications which indicate publication of new content. An example of such an event-based data aggregation system and related techniques is described in U.S. Patent Publication No. US-2006-0004691-A1 (Attorney Docket No. TECHP001), the entire disclosure of which is incorporated herein by reference for all purposes.

It will be understood that the foregoing are merely examples of data sources which may be used with specific embodiments of the present invention. Any data source which is updated in real time or near real time (as opposed to the manner in which conventional search engine databases are updated), as well as any data set derived from such data sources, may be employed (either by itself or in combination with other such data sources and data sets) without departing from the scope of the invention.

According to one example implementation, the data source(s) include about 200 live feeds from a collection of web sites, the information from which is continually indexed. Periodically (e.g., every half hour, or after some number of the feeds have updated), one or more keyword extraction algorithms are applied to at least a portion of the indexed information to determine whether any newly relevant keywords are occurring.

The overall quality of the keywords extracted may be enhanced by a number of techniques which may be applied individually or in combination. For example, the individual feeds employed may be selected with regard to their reliability, e.g., respected news feeds from Reuters and the Associated Press. Feed selection may be manual (e.g., a system administrator selects the feeds) or it may also be automated (e.g., the top 100 most widely subscribed feeds). In addition, pre-filtering techniques may be employed to ensure that only the most important information from the feeds selected makes it into the data set for subsequent keyword extraction analysis.

In another example, the data source is derived with reference to publication events from the blogosphere, i.e., Web log updates are indexed as they are published. The information being indexed may include “tags,” categories or some form of hierarchical categorization information, or other groupings by which the information is categorized or classified (typically by the content publisher himself) which may also be useful in determining a set of blogs to use as input to the data source. For example, such tags could indicate that the published subject matter relates to politics, finance, entertainment, consumer electronics, sports, etc. Thus, a set of blogs may be identified as relating to particular subject matter with reference to such tags which may then be used as the data source from which keywords are derived.

According to a specific embodiment, a set of feeds or portion of a data set may further be determined with reference to the relative authority, relevance, or popularity of the content publishers, e.g., bloggers, either in general or with regard to a particular subject matter area. That is, the strength of the data set from which keywords are extracted may be enhanced by selecting input feeds or data from sources which are considered authoritative, relevant to a topic, or which are popular. Such an authority, relevance, or popularity measure may be determined, for example, by determining the number of inbound links directed to the corresponding feed or site, e.g., how many people link to an individual's blog. A variety of techniques for identifying the subject matter and authority, relevance, or popularity associated with content published on the Web is described, for example, in U.S. Patent Publication No. US-2006-0004691-A1 incorporated herein by reference above. However, it will be understood that a wide variety of techniques for identifying subject matter, relevance, and/or authority or popularity may be employed without departing from the scope of the invention.

According to various embodiments of the invention, a wide variety of different keyword extraction techniques (some of which may depend on the manner in which the data source is generated) may be employed to identify newly relevant keywords. For example, for embodiments in which the data source is derived from one or more live feeds or content posts based on a particular tag, a variety of conventional statistical term frequency matching techniques may be employed to identify the occurrence of words and phrases which are statistically unusual. This may be done with or without reference to the historical usage of such words and phrases in the data source. That is, for example, words in the English language have relatively well understood statistical frequencies of usage. When particular words or phrases significantly exceed their expected frequencies, these words may be candidates for extraction.

Alternatively, the historic usage of particular keywords may be taken into account when determining whether a currently measured deviation from statistical frequency warrants identification of a keyword as a candidate. For example, a baseline for particular keywords may be established with reference to historic usage, to thereby more accurately determine whether the keywords are actually becoming currently relevant. For example, given their relative frequency of use, the names of athletes, celebrities, and politicians will appear relevant if compared to their static statistical likelihood of occurrence in the English language. However, if such names are instead compared against a baseline determined with reference to their historical usage, the comparison is much more likely to result in the identification of names which are actually currently relevant. Such a baseline optimization may be employed in determining whether any keyword or tag regardless of the source has current relevance.

For embodiments in which the data source is live search query traffic, very little or even no filtering or selection may need to be done. That is, the search terms themselves may be identified as the keyword candidates. Alternatively, some filtering or processing may be done to remove some of the words from similar search queries to identify common elements which might have greater overall relevancy. For example, from the two currently relevant search terms “alpha beta gamma” and “beta gamma delta”, the more generic (and therefore likely more relevant) keyword “beta gamma” may be derived.

For embodiments in which the data source is a database generated by an event-based data aggregation system, any of the keyword extraction techniques described herein may be employed to identify currently relevant keywords. In addition, the scope of the data set to which such techniques are applied may be narrowed using only a portion of the database, e.g., a slice relating to particular subject matter areas, social networks, authoritative sources, time periods, various combinations of these, etc. Any way that such a database can be sliced may represent a useful data set from which currently relevant keywords can be extracted.

Not only can the techniques of the present invention be adapted to beat the market to particular keywords, because some of these techniques also have an understanding of subject matter areas to which the keywords are relevant, e.g., with reference to tags, metadata, or other hierarchical categorization information associated with the publication sources, the content of advertisements which are presented in response to the use of the keywords in search engines may be tailored to be relevant to the same subject matter area, thereby potentially improving CTR. For example, political ads could be presented in response to a keyword which is understood to be related to an unfolding political scandal (e.g., because of tags associated with blog posts).

Alternatively or additionally, keywords may be categorized by subject matter so that they may be sold as a group. That is, currently relevant keywords relating to the subject matter area of politics may be aggregated and sold together as a unit to an entity desiring click-through traffic from users of search engines who have an interest in politics (as determined by their use of one of the keywords in the group). And, as will be described below, the dynamic nature of such groups should keep their relevancy current and their effectiveness high.

This approach is to be contrasted with conventional techniques in which groups of keywords are sold together. For example, an advertiser of global vacation travel services might buy or bid on a static group of keywords which includes city names around the world. In response to the appearance of such city names in search queries, ads are placed which incorporate the city name, but which do not take into account the current relevancy of the city name to the market for the advertised services, e.g., vacation tours to Baghdad. By contrast, if keyword relevancy is determined relative to a particular subject matter area, e.g., leisure travel, such a result is unlikely to occur.

According to various embodiments, the tags, categories, other hierarchical categorization information, authors, and/or other metadata associated with recent posts or publications of content may, themselves, be employed as keywords. That is, for example, because tags are also being received in real time or near real time, it is possible to identify, for example, subject matter areas or topics about which there is currently a significant exchange of information. Thus, the tags themselves can be identified as keyword candidates. As with live search queries, tags may need little or no analysis or processing to determine relevance in that tags are inherently intended to signify relevance of the corresponding subject matter being posted and to correspond to keywords in live search queries.

According to some embodiments, additional analysis may be performed on a set of keyword candidates to identify other keyword candidates which might not be readily apparent from the original data set. For example, if a political scandal was unfolding relating to a relatively unknown member of a state assembly, most of the initial search queries relating to the event would typically not employ the name of the politician, e.g., “California state assembly scandal.” However, a cluster analysis employing this keyword and other near or real-time data sources likely would reveal the name of the politician and possibly even the nature of the scandal, thus potentially providing keyword candidates which are soon to be relevant, e.g., “Assemblyman John Smith bribery.” Such an analysis might also be used to identify a relevant subject matter area, e.g., politics, which could then be used as described above, for example, to tailor the content of the resulting advertisements or to add the new keywords to a subject-matter-specific keyword group. As will be understood, this type of further analysis may be performed regardless of the initial data source from which a keyword candidate was derived or extracted.

Referring once again to FIG. 1, once a group or list of currently relevant keyword candidates are identified using any of the above or similar techniques (102), an analysis is performed on each candidate to determine whether use of the keyword in an advertising campaign will be productive or beneficial (104). According to some embodiments, this determination may be done by assigning all keyword candidates the same maximum CPC. Alternatively, different keywords may be assigned different maximum CPCs depending on their relative importance, i.e., the entity placing the ads may be willing to pay more for some keywords than others. This relative importance might be determined, for example, with reference to previous CTR performance, current bid levels, willingness of the advertiser to pay, historical CPA performance (i.e., actions taken by people who clicked), etc.

According to various specific embodiments of the invention, one or more automated processes are configured to interact with the systems of search engine advertising providers (e.g., Google, Yahoo, Microsoft, etc.) through APIs made available by these providers to make this determination. For example, according to a specific embodiment, for each keyword in the list of candidates such an automated process might determine with reference to a particular advertising provider's system what the current minimum bid is for the keyword, and whether and how many bids for that keyword already exist in the system.

If use of the keyword appears that it will be productive, e.g., the conditions are suitable for prominent placement of an ad for that keyword at the associated CPC (106), then an advertising campaign using that keyword is initiated (108). The determination as to whether the current market conditions are suitable for a given keyword may vary considerably depending on a variety of factors including, for example, one or more current market conditions relating to the specific keyword, how many ads can be shown on a search results page, the goals of the entity generating the keywords and/or the advertiser, agreements between the entity generating the keywords and the advertising provider, etc. For example, the logic by which the determination is made may be configured such that if 5 ads can be shown on a search results page and there are only 2 bids currently in the system for the particular keyword, and the minimum bid required by the advertising provider is less than or equal to the maximum bid specified for the keyword, then the campaign could be initiated.

The foregoing example assumes initiating a campaign with the keyword where the current conditions guarantee placement of the ad on the first search results page for less than the specified maximum CPC. However, an advertiser might be willing to pay more than the specified maximum if it can be guaranteed that the ad will be placed on the first search results page. In such case, the logic could be set up such that the maximum bid limitation might only come into play if the ad is not guaranteed to be presented on the first page of organic search results.

Alternatively, an advertiser might be willing to allow a campaign to proceed even if placement on the first search results page is not guaranteed (e.g., as long as it is placed in the top 2 or 3). In other words, the determination of whether to proceed with a campaign for a particular keyword, and the metrics with reference to which such a determination is made may vary considerably without departing from the scope of the invention.

According to specific embodiments of the invention, the processes of determining a list of keywords and selectively initiating campaigns are iterated (110) so that newly relevant keywords may be identified and/or the campaigns for previously identified keywords to which the market has adjusted may be modified or terminated. It should be noted that, given the time frames which are typical in determining current relevancy, e.g., minutes or hours, the frequency of iteration may be relatively high. In addition, because there is typically very little or no dependency between different keywords, the automated processes which make these determinations are highly parallelizable. That is, a great number of computing devices may be configured to perform these determinations and to initiate, track, modify, and terminate campaigns, and to iterate for new keywords to better take advantage of the timeliness of the dynamic data set and the real-time or near-real-time data sources from which the data set is derived.

As will be understood, when initiating a keyword advertising campaign with a search engine provider, along with the keyword and CPC bid, an overall spending cap is typically specified, e.g., the amount the advertiser is willing to spend on the campaign before it is terminated. In addition and according to some embodiments, once campaigns for particular keywords are initiated, the performance of those campaigns (i.e., how “productive” the campaigns are) and the evolution of the markets for those keywords are tracked (112) so that decisions can be made as to whether to modify or terminate any campaigns before any specified spending cap is reached.

As with the determination about whether to initiate a campaign, the metrics by which the productivity of an ongoing campaign is measured may vary considerably without departing from the scope of the invention. For example, an ongoing campaign may be evaluated relative to the market for the corresponding keyword, e.g., if the minimum CPC required by the advertising provider and/or the number of current bids for the keyword has increased. Alternatively, or in addition, the number of times an ad has been placed at or near the top of the first page of organic search results could be monitored.

An important metric which may be tracked for an ongoing campaign is the click-through-rate (CTR) for ads placed as part of the campaign. This is particularly important in view of the fact that search engine advertising providers typically penalize advertisers who place ads for which the CTR is very low, e.g., by requiring high minimum CPCs. In such cases, it may be advantageous for the advertiser to terminate campaigns for which the CTR is underperforming even where the specified cap has not been reached. Alternatively, where the CTR is high and the advertiser's spending cap may be quickly exhausted, it may be desirable to be aware of the run rate so that the advertiser has an opportunity to modify the campaign, e.g., refund or increase the spending cap, or to re-initiate the campaign.

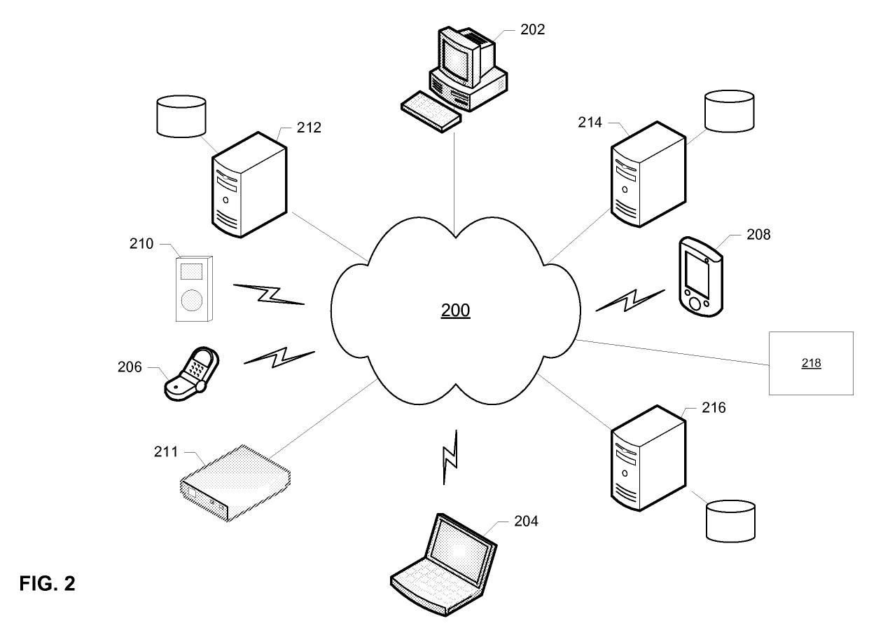

FIG. 2 shows an example of a network environment in which embodiments of the present invention may be implemented. It will be understood that this simplified diagram is intended to represent the great diversity of network topologies, network types, subnetworks, and computing platforms and devices which may be involved in such implementations. For example, network cloud 200 may represent, in whole or in part and without limitation, the Internet, the World Wide Web, public networks, private networks, local area networks, wide area networks, enterprise networks, telecommunications networks, cable networks, satellite networks, home networks, etc., or any combination of any of the foregoing or their equivalents.

Computing devices with which end users may interact with embodiments of the invention may be similarly diverse including, for example, wired and wireless desktop computers 202 and laptop computers 204, handheld devices (e.g., cell phones 206, PDAs 208, portable media players 210, and any of the increasing number of handheld devices in which these functionalities are converged, etc.), set top boxes 211, etc. Other computing platforms in the network (e.g., servers 212, 214, 216) may represent and/or be operated by, without limitation, search engine providers, advertising providers, advertisers, content providers and publishers, merchants, virtually any type of web site, etc., as well as advertising keyword providers who provide services in accordance with embodiments of the invention, e.g., entities who provide “keyword arbitrage” services to third-party advertisers.

The real-time and near-real-time data sources which may be used with various embodiments of the invention may be derived from a variety of sources in network 200. For example, as described above, live feeds may be RSS feeds from an arbitrary number of web sites. API calls, including without limitation ATOM feeds, microformatted HTML, etc., may also be used to gather relevant timely information. In other examples, live query traffic may be derived from search engines and/or search services on web sites. According to a specific class of embodiments mentioned above, real-time and near-real-time data are indexed by an event-based data aggregation system 218 which may be implemented in accordance with the techniques described in U.S. Patent Publication No. US-2006-0004691-A1 incorporated herein by reference above. As will be understood, any of these types of sources, as well as data sources having similar characteristics, may be used in various combinations to implement embodiments of the present invention.

Additionally, it will be understood that the techniques for selecting keywords and initiating keyword campaigns according to various embodiments of the invention may be implemented and executed, without limitation, on one or more computing platforms using any of a wide variety of programming tools and languages, and according to any suitable computing model. The diversity of options for implementing the techniques of the present invention are apparent to those of skill in the art.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein which take advantage of APIs exposed by conventional search providers to facilitate selection of keywords and initiation, monitoring, modification, and termination of advertising campaigns. However, it will be understood that embodiments of the invention are contemplated which do not require interfacing with such providers. That is, for example, such embodiments might be carried out by an entity having its own advertising platform and would therefore not require such an interface.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

1. A computer-implemented method for selecting advertising keywords for advertising campaigns, comprising:
identifying a set of keywords from a dynamic data set, the dynamic data set being generated from at least one data source which is updated via the Internet substantially in real time, each keyword in the set of keywords being characterized in the dynamic data set by a current relevancy measure not yet apparent from conventional search engine databases;
selecting a subset of the keywords for use in the advertising campaigns with reference to at least one current market condition relating to each selected keyword; and
initiating advertising campaigns for each of the selected keywords.

2. The method of claim 1 wherein the at least one data source comprises one or more of a live data feed, search query traffic, or an event-based data aggregation system.

3. The method of claim 1 wherein identifying the keywords comprises performing a frequency analysis on the dynamic data set to identify frequently occurring words.

4. The method of claim 3 further comprising comparing at least some of the frequently occurring words to a baseline frequency measure representing historic usage of the at least some of the frequently occurring words.

5. The method of claim 1 wherein the at least one current market condition relating to each selected keyword comprises one or more of a current number of bids for the selected keyword, a current minimum bid price for the selected keyword, a first bid price required to guarantee ad placement on a first page of organic search results, or a number of ads displayed on each page of organic search results.

6. The method of claim 1 wherein the dynamic data set is characterized by one or more of a subject matter area, relative authority of content publishers associated with the at least one data source, a social network, a collection of blogs, or any editorially determined data source.

7. The method of claim 6 wherein the dynamic data set is characterized by a subject matter area, and wherein the subject matter area is determined with reference to one or more of content tags, hierarchical categorization information, metadata, content publishers, or content analysis results.

8. The method of claim 6 wherein the dynamic data set is characterized by relative authority of content publishers, and wherein the relative authority is determined with reference to inbound links associated with the content publishers.

9. The method of claim 1 further comprising iterating one or more of identifying the keywords, selecting a subset of the keywords, and initiating the advertising campaigns.

10. The method of claim 1 further comprising monitoring the advertising campaigns with reference to at least one performance metric, and subsequently modifying or terminating at least some of the advertising campaigns in response thereto.

11. The method of claim 10 wherein the at least one performance metric comprises one or more of a click-through rate, a minimum cost-per-click, or a cost-per-acquisition.

12. The method of claim 1 wherein selecting the subset of the keywords and initiating the advertising campaigns are both facilitated via an application programming interface associated with a keyword advertising service provider.

13. (canceled)

14. A computer program product for selecting advertising keywords for advertising campaigns, the computer program product comprising at least one computer-readable medium having computer program instructions stored therein which are operable when executed by at least one computer to:
identify a set of keywords from a dynamic data set, the dynamic data set being generated from at least one data source which is updated via the Internet substantially in real time, each keyword in the set of keywords being characterized in the dynamic data set by a current relevancy measure not yet apparent from conventional search engine databases;
select a subset of the keywords for use in the advertising campaigns with reference to at least one current market condition relating to each selected keyword; and
initiate advertising campaigns for each of the selected keywords.

15. The computer program product of claim 14 wherein the at least one data source comprises one or more of a live data feed, search query traffic, or an event-based data aggregation system.

16. The computer program product of claim 14 wherein the computer program instructions are operable when executed by the at least one computer to identify the keywords by performing a frequency analysis on the dynamic data set to identify frequently occurring words.

17. The computer program product of claim 16 wherein the computer program instructions are further operable when executed by the at least one computer to compare at least some of the frequently occurring words to a baseline frequency measure representing historic usage of the at least some of the frequently occurring words.

18. The computer program product of claim 14 wherein the at least one current market condition relating to each selected keyword comprises one or more of a current number of bids for the selected keyword, a current minimum bid price for the selected keyword, a first bid price required to guarantee ad placement on a first page of organic search results, or a number of ads displayed on each page of organic search results.

19. The computer program product of claim 14 wherein the dynamic data set is characterized by one or more of a subject matter area, relative authority of content publishers associated with the at least one data source, a social network, a collection of blogs, or any editorially determined data source.

20. The computer program product of claim 19 wherein the dynamic data set is characterized by a subject matter area, and wherein the subject matter area is determined with reference to one or more of content tags, hierarchical categorization information, metadata, content publishers, or content analysis results.

21. The computer program product of claim 19 wherein the dynamic data set is characterized by relative authority of content publishers, and wherein the relative authority is determined with reference to inbound links associated with the content publishers.

22. The computer program product of claim 14 wherein the computer program instructions are further operable when executed by the at least one computer to iterate one or more of identifying the keywords, selecting a subset of the keywords, and initiating the advertising campaigns.

23. The computer program product of claim 14 wherein the computer program instructions are further operable when executed by the at least one computer to monitor the advertising campaigns with reference to at least one performance metric, and subsequently modify or terminate at least some of the advertising campaigns in response thereto.

24. The computer program product of claim 23 wherein the at least one performance metric comprises a click-through rate.

25. The computer program product of claim 14 wherein the computer program instructions are operable when executed by the at least one computer to select the subset of the keywords and initiate the advertising campaigns via an application programming interface associated with a keyword advertising service provider.

26. (canceled)

27. A system for selecting advertising keywords for advertising campaigns, the system comprising at least one computing platform configured to:
identify a set of keywords from a dynamic data set, the dynamic data set being generated from at least one data source which is updated via the Internet substantially in real time, each keyword in the set of keywords being characterized in the dynamic data set by a current relevancy measure not yet apparent from conventional search engine databases;
select a subset of the keywords for use in the advertising campaigns with reference to at least one current market condition relating to each selected keyword; and
initiate advertising campaigns for each of the selected keywords.
